(19) United States
(12) Patent Application Publication
(10) Pub. No.: US 2026/0172812 A1
(43) Pub. Date: Jun. 18, 2026

(54) METHODS, ARCHITECTURES, APPARATUSES, AND SYSTEMS FOR SELECTIVE SENSING DATA POINT COORDINATION AND CONFIGURATION FOR MOBILE SYSTEMS

(71) Applicant: InterDigital Patent Holdings, Inc., Wilmington, DE (US)

(72) Inventors: Muhammad Awais Jadoon, London (GB); Sebastian Robitzsch, London (GB); Filipe Conceicao, London (GB)

(21) Appl. No.: 18/981,289

(22) Filed: Dec. 13, 2024

(51) Int. Cl. H04W 8/22; H04L 41/14; H04W 24/10

(52) U.S. Cl. CPC H04W 8/22; H04L 41/14; H04W 24/10

(57) ABSTRACT

Procedures, methods, architectures, apparatuses, systems, devices, and computer program products are provided for a wireless transmit/receive unit (WTRU) to communicate with a wireless network. The WTRU transmits capability information to the network and receives configuration information, which includes identifiers for a set of sensing data points. The WTRU receives a sensing signal, measures the identified data points, generates sensing measurement information, and transmits this information back to the network. The network can update the configuration information, prompting the WTRU to repeat the process with a new set of data points. The configuration information may include reporting intervals and threshold values for the sensing data points, which can be adjusted based on network conditions. A sensing function (SF) and a sensing analytics function (SAF) may be provided within the network. The method ensures efficient and adaptive sensing data collection and reporting by the WTRU.

### TECHNICAL FIELD

The present disclosure is generally directed to the fields of communications, hardware, software and encoding, including, for example, to methods, architectures, apparatuses, and systems related to integrated sensing and communication (ISAC) in wireless networks, including sensing data points configuration.

### BACKGROUND

For implementation of ISAC, generalized and aspirational applications, scenarios, service requirements, performance metrics, interoperability, security considerations, system architectures, key network functions, interfaces, protocols, and deployment scenarios are provided. However, numerous technical challenges for ISAC implementation remain.

### SUMMARY

In certain representative embodiments, a method performed by a wireless network comprises one or more steps. A method comprises a wireless transmit/receive unit (WTRU) communicating with a wireless network. The WTRU sends capability information to the wireless network, indicating measurement capabilities. The network responds with configuration information that includes identifiers for a set of sensing data points. The WTRU receives a sensing signal, measures the specified data points, generates sensing measurement information, and transmits information back to the network. The network can update the configuration information, prompting the WTRU to repeat the process with a new set of data points.

The configuration information may specify a reporting interval for each data point, which can be periodic, aperiodic, stream, or single. These intervals can be adjusted based on the type of data point and the target object. The configuration may also include threshold values for the data points, and the WTRU sends measurement information only if these values are met or exceeded. These threshold values can be adjusted based on network conditions, and the updated configuration information may indicate new threshold values for the data points.

The sensing measurement information is received by a sensing analytics function (SAF) within the network. The WTRU includes a processor and a transceiver, enabling it to perform these steps. The network can receive a sensing service request, which indicates initial performance indicators. Based on the indicators, the network determines relevant sensing data points and sends configuration information to the WTRU. The sensing service request is processed by various functions within the network, including a sensing function (SF) and a sensing analytics function (SAF), to determine and transmit the appropriate configuration information to the WTRU.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit and/or receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of robots, controlled by a digital twin (DT) for performing one or more sensing tasks with changing key performance indicator (KPI) requirements, in accordance with some embodiments of this disclosure;

FIG. 3 is a diagram illustrating an example of a functionality of a sensing function (SF) (e.g., to choose transmission of corresponding sensing data points), in accordance with some embodiments of this disclosure;

FIG. 4 is a further example of sensing analytics function (SAF) mapping of KPI requirements (e.g., to a set of sensing data points denoting data points and time requirements), in accordance with some embodiments of this disclosure;

FIG. 5 is a sequence diagram illustrating an example sequence of a procedure to configure sensing reception (e.g., configuring WTRUs or base stations for sensing reception with data points to measure and report, and corresponding threshold values of each data point), in accordance with some embodiments of this disclosure;

FIG. 6 shows new exemplary functions, in accordance with some embodiments of this disclosure;

FIG. 7 is a procedural diagram illustrating an example procedure for a wireless device to communicate capabilities to a network, receive configuration information, measure specified data points based on a sensing signal, and transmits the measurement information back to the network, in accordance with some embodiments of this disclosure; and

FIG. 8 is a procedural diagram illustrating an example procedure for a wireless network to receive a sensing service request, determine relevant sensing data points based on performance indicators, and send configuration information to a wireless device, in accordance with some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

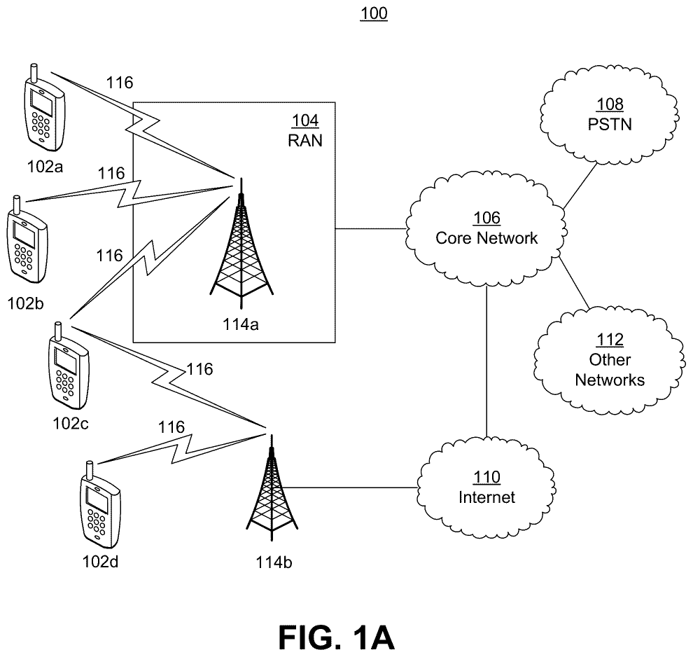

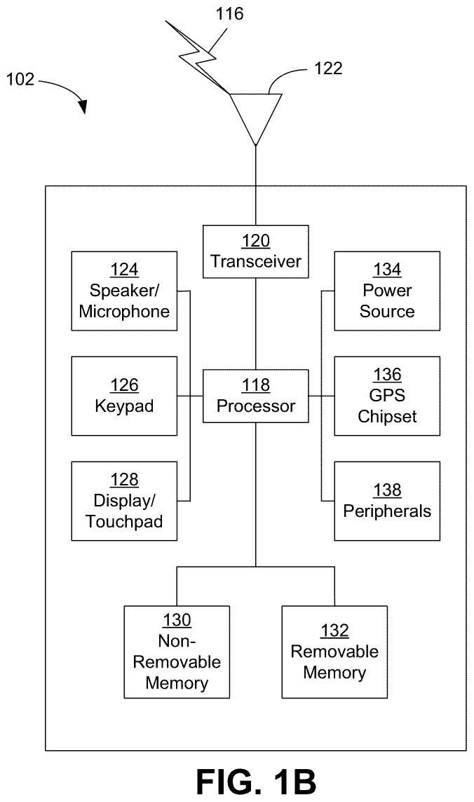

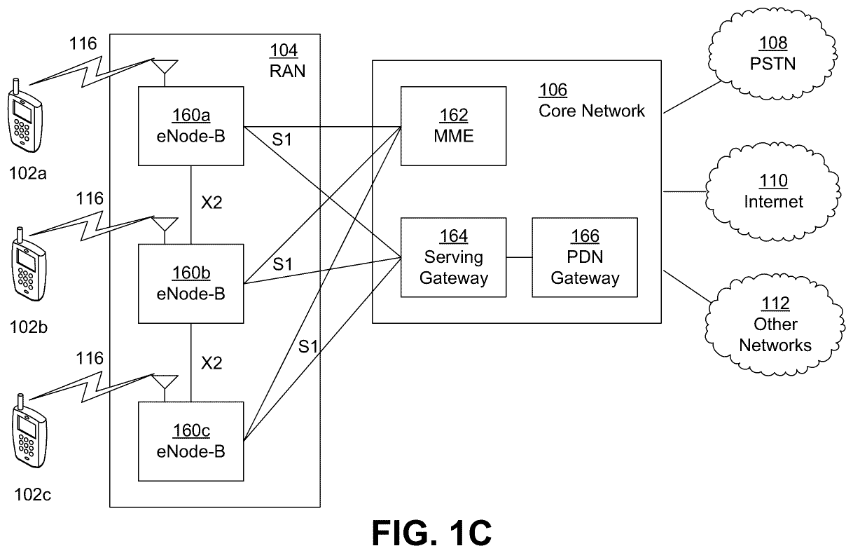

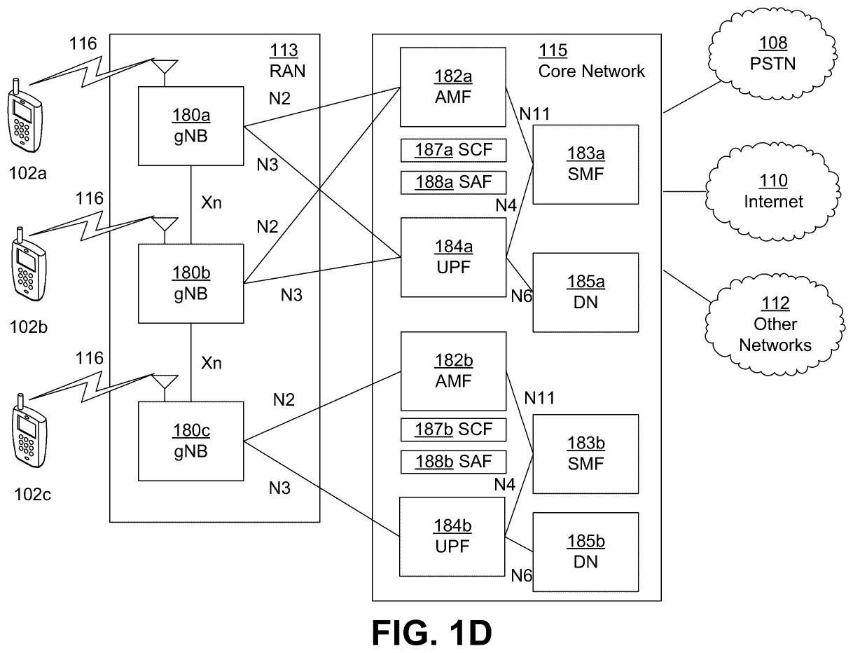

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable radio access technology (RAT) for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, at least one Data Network (DN) 185a, 185b, at least one Sensing Coordination Function (SCF) 187a, 187b, and at least one Sensing Analytics Function (SAF) 188a, 188b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In certain representative embodiments, selective sensing data point coordination and/or configuration for mobile systems is provided. For example, sensing data points configuration is provided for ISAC. Also, for example, selective sensing data point coordination comprises at least one of sensing data point configuration procedures, sensing report procedures, sensing functions (SF) functionality and procedures, sensing analytics function (SAF) procedures, combinations of the same, or the like. Further, for example, a method comprises at least one of: a WTRU receives a configuration from a network function (e.g., an SF) to measure and report a subset of sensing data points (e.g., instead of all data points for a sensing task, to meet KPI requirements of the task); the SF requests the SAF to provide a list of the sensing data points to be measured (e.g., in order to meet one or more KPI requirements of the sensing task); the SF provides the (e.g., KPI) requirements to the SAF in the request; the SF chooses the WTRU and a corresponding list of sensing data points the WTRU will measure and/or report for a given sensing task and/or target; combinations of the same; or the like.

In certain representative embodiments, WTRU reports a subset of data points (e.g., configured by an SF). For example, a method comprises at least one of: registering capabilities of the WTRU (e.g., with the SF); detailing measurable data points during setup or sensing tasks; configuring (e.g., by the SF) the WTRU to measure and report specific data points (e.g., with thresholds); measuring and/or reporting data points (e.g., to the SAF; e.g., only reporting those that meet threshold conditions if set); receiving updated configurations for different data points; combinations of the same; or the like. Also, for example, the WTRU reports and/or exposes and/or registers capabilities of the WTRU to the SF. Further, for example, the capabilities indicated are in terms of data points that a WTRU can measure. In addition, for example, the WTRU reports the capabilities during the initial registration phase and/or before and/or during a sensing task. Moreover, for example, the WTRU receives a configuration (e.g., from the SF) to measure a subset of all available sensing data points. Furthermore, for example, the configuration contains a list of sensing data points (e.g., which are to be measured and reported). Additionally, for example, the configuration contains threshold values for each sensing data point as a trigger to report measured values (e.g., for each sensing data point). Still further, for example, the WTRU measures a subset of sensing data points. Even further, for example, the WTRU sends the measured sensing data points as part of a sensing measurement report (e.g., to the SAF). Yet further, for example, if the SF configured thresholds for one or more sensing data points, the WTRU reports only sensing data point for which the corresponding threshold condition are met. Further still, for example, the WTRU receives an updated configuration to measure and report another subset of sensing data points.

In certain representative embodiments, a network function (e.g., an SAF) provides data points to be measured (e.g., by WTRUs) and the network function or another network function (e.g., an SF) maps one or more sensing objects (e.g., WTRUs) to the data points. For example, a method comprises at least one of receiving (e.g., at the SF) a sensing service request (e.g., from the AF; e.g., with initial KPI requirements; e.g., for sensing results); a list of sensing data points is requested (e.g., the SF requests the SAF for the list; e.g., the WTRU will be configured to measure the some or all of the sensing data points; e.g., to meet KPI requirements); one or more (e.g., KPI) requirements (e.g., from the AF) are associated (e.g., at the SAF) to one or more specific sensing data points (e.g., as part of a request); a list of the one or more specific sensing data points is sent (e.g., by the SAF to the SF); a WTRU is selected (e.g., by the SF); one or more data points for measurement and reporting are selected (e.g., by the SF); a configuration is sent to the WTRU (e.g., by the SF); combinations of the same; or the like. Also, for example, if KPI requirements change, (e.g., the SF) requests an updated list of sensing data points (e.g., from the SAF) and (e.g., the SF) chooses a different WTRU and data points and configures the different WTRU accordingly. Further, for example, one or more method steps are repeated for the different WTRU.

In certain representative embodiments, in combination with one or more feature provided herein, ISAC is provided for detection and tracking of non-connected objects in an environment. For example, in the context of ISAC, detection and/or tracking are provided. Also, for example, detection and/or tracking of automated guided vehicles (AGVs) is provided, e.g., in factories, for health monitoring, for environment reconstruction, for gesture recognition of humans, or the like. Further, for example, sensing of one or more objects is performed by measuring different data points at a receiver and a set of the data points is referred to as sensing data. In addition, for example, if a receiver measures angle of arrival (AoA), doppler shift, micro-doppler shift, delay, or the like, then each of these measurements are called sensing data points.

Sensing data is used, for example, to generate sensing results that are requested by a sensing service. Also, for example, sensing results are generated by fusion of one or more sensing data streams or by fusing a subset of data points to an already existing sensing data stream.

For ISAC, for example, a process is provided for collecting sensing measurement data, which is data collected about radio and/or wireless signals impacted (e.g., reflected, refracted, diffracted, or the like) by an object or environment of interest for sensing purposes. Also, for example, sensing results are derived (e.g., at a wireless network) as a result of processing sensing measurement data.

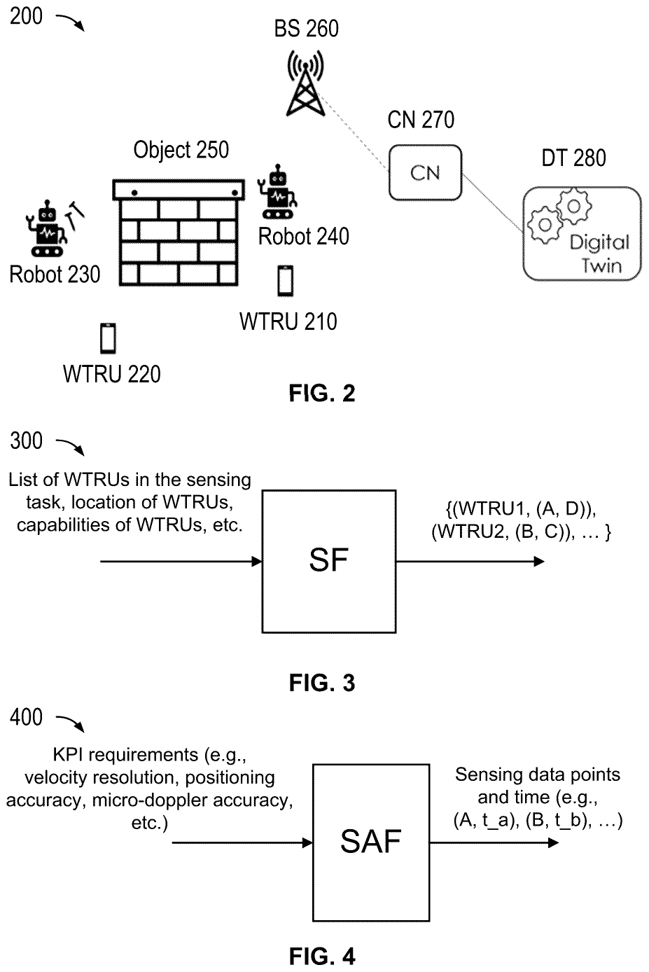

In certain representative embodiments, as shown in FIG. 2, a system 200 includes at least one of a first WTRU 210, a second WTRU 220, a first robot 230, a second robot 240, an object 250, a base station (BS) 260, a core network (CN) 270, and a digital twin (DT) 270. For example, the robots 230, 240 are controlled by the DT 270. The DT 270 may function as a control hub for the robots 230 and 240, providing instructions and monitoring performance in real-time. Also, for example, at least one of the WTRUs 210, 220, the robots 230, 240, combinations of the same, or the like perform one or more sensing tasks. The WTRUs and robots may be equipped with sensors to perform various tasks such as environmental monitoring, object detection, or data collection. The tasks can be performed individually or in combination. Further, for example, one or more sensing tasks are performed with one or more changing KPI requirements. In addition, for example, the sensing tasks are dynamic and adapt to changing KPIs. Furthermore, for example, the KPIs include metrics (e.g., latency, accuracy, energy efficiency, or the like).

For example, one or more AGVs are controlled using the DT 270. The DT 270 acts as an application function (AF) and provides one or more KPI requirements for a particular sensing task. In the context of a smart factory environment, for example, one or more AGVs (e.g., robots 230, 240) perform different tasks at the same time. For instance, the AGVs might be drilling a hole in the object 250 (e.g., a wall) to insert a wooden or metallic rod; the AGVs might be putting the rods on a conveyer belt (not shown); or an AGV might be moving towards performing a different task. In addition, for example, if the AGVs are targets of a sensing task, tasks to be performed by the AGVs are divided into categories, e.g., holistic tasks and precision tasks. Holistic tasks (e.g., the AGV moving) may require one or more holistic sensing tasks. Precision tasks (e.g., drilling a hole in a wall and placing a rod in the hole) may require one or more precision sensing tasks.

Both holistic sensing and precision sensing may require computation of different data points. For instance, holistic sensing may require determination of delay, doppler, and angle measurements as sensing data points and may not require micro-doppler or determination of a radar cross section (RCS) of the target (e.g., object 250). Also, for example, precision sensing may require determining micro-doppler for micro movements within the target and precise localization of the point where hole is to be drilled. Further, for example, KPI requirements may be changed by the DT 270 depending upon the underlying task the AGVs might be performing. In this case, the AGVs may be considered as sensing targets or sensing receivers and a rod could be a sensing target.

In certain representative embodiments, requirements for one or more sensing KPIs change over time and/or during a sensing task, e.g., holistic sensing and precision sensing. In an approach, a sensing receiver generates sensing data and all sensing data points are measured. However, measuring all sensing data points may not be energy and resource efficient, and reporting such data points may incur unnecessary signaling overhead, e.g., in bistatic or multistatic sensing scenarios where a sensing receiver (e.g., WTRU or BS) is measuring sensing data from sensing signals.

In certain representative embodiments, a network is configured to be selective. For example, a network configures a sensing receiver (e.g., WTRU or BS) for one or more specific data points to be reported that are required to produce sensing results. Also, for example, the network configures the sensing receiver for the one or more specific data points to be reported that are required to produce the sensing results (e.g., while meeting one or more sensing task KPIs).

Exemplary terminology is provided. A sensing signal is, for example, a transmitted signal from 6th Generation (6G) RF or non-6G RF for the purpose of sensing. A sensing service is, for example, a feature of a 6G System (6GS) that is offered to consumers. Also, for example, a sensing service provides one or more sensing results based on communicated requirements and KPIs, as per the issued service request. A sensing receiver is, for example, an entity that receives the sensing signal, which the sensing service will use in an operation. The sensing receiver may be a WTRU and/or a BS. The sensing receiver can be located in the same or different entity as the sensing transmitter. A sensing transmitter is, for example, the entity that sends out the sensing signal which the sensing service will use in its operation. A sensing transmitter is, for example, part of a RAN node or a WTRU. A sensing transmitter can be located in the same or different entity as the sensing receiver. A sensing measurement report is, for example, a configured report from the sensing receiver. Sensing data is, for example, the content of the sensing measurement report. Sensing results are, for example, processed or non-processed sensing data from sensing measurement reports. The processed sensing data may include, e.g., point cloud, object identification (e.g., size, shape, material, or the like) or other contextual information about objects in a target sensing service area (TSSA) using further analytics. A sensing task, for example, identifies activities to perform sensing using 6G RF or 6G non-RF sensing signals. A sensing group is, for example, a set of sensing transmitters and sensing receivers whose location is known and whose sensing data can be collected synchronously.

In the context of 3GPP, for example, the network exposure function (NEF) is a component that provides secure and standardized access to network services and capabilities. Also, for example, the NEF acts as an intermediary between external applications and the (e.g., 5th Generation (5G)) core network, exposing network functions and data through application programming interfaces (APIs) (e.g., while ensuring security and policy compliance). The NEF enables third-party applications to interact with the network, facilitating services like IoT and enhanced mobile broadband.

For example, the policy control function (PCF) is responsible for managing network policies and ensuring that the network operates according to predefined rules. Also, for example, the PCF controls the QoS, enforces charging policies, and controls network slicing, which allows the network to be divided into multiple virtual networks tailored to different services or customers. The PCF plays a role in maintaining the efficiency and reliability of the network by dynamically adjusting policies based on real-time conditions and requirements.

For example, a tracking area (TA) is a geographical region within a mobile network that is used to control and track the location of user equipment (e.g., a WTRU). Also, for example, each TA consists of multiple cells, and the network uses TAs to control mobility and paging procedures. When a WTRU moves from one TA to another, the WTRU performs a tracking area update to inform the network of its new location, which helps in resource allocation and reducing signaling overhead.

For example, unified data management (UDM) is a centralized function that controls subscriber data and authentication in the (e.g., 5G) core network. Also, for example, the UDM stores and controls user profiles, subscription information, and authentication credentials. UDM interacts with other network functions to provide seamless access to services, ensuring that users are authenticated and authorized to use the network. It also supports mobility management by maintaining up-to-date information about the user's location and service preferences.

In the context of ISAC, one or more of the above-referenced components work together to enhance the network's ability to support advanced applications. For example, the NEF facilitates the integration of sensing data from external sources, the PCF ensures that the network policies are adapted to support high-precision sensing and communication tasks, the TAs help in efficiently managing the mobility of devices involved in sensing activities, and the UDM provides user data management functions to support seamless and secure access to ISAC services.

In certain representative embodiments, architectural components are provided in existing 5G System (5GS) core network architecture to coordinate sensing tasks and to configure sensing transmitters and receivers to perform a sensing task. For example, a sensing measurement report indicates each sensing measurement, which comprises a list of sensing data points. For instance, each measurement at the physical layer (e.g., measurement of angle and/or phase, delay and/or TDoA and/or ToA, doppler, micro-doppler, or the like) or a measurement that is a function of other measurements such as RCS, is considered a sensing data point. Also, for example, sensing data points such as delay, doppler, micro-doppler, angles and/or phase, or the like, are denoted as A, B, C, D, or the like in this disclosure.

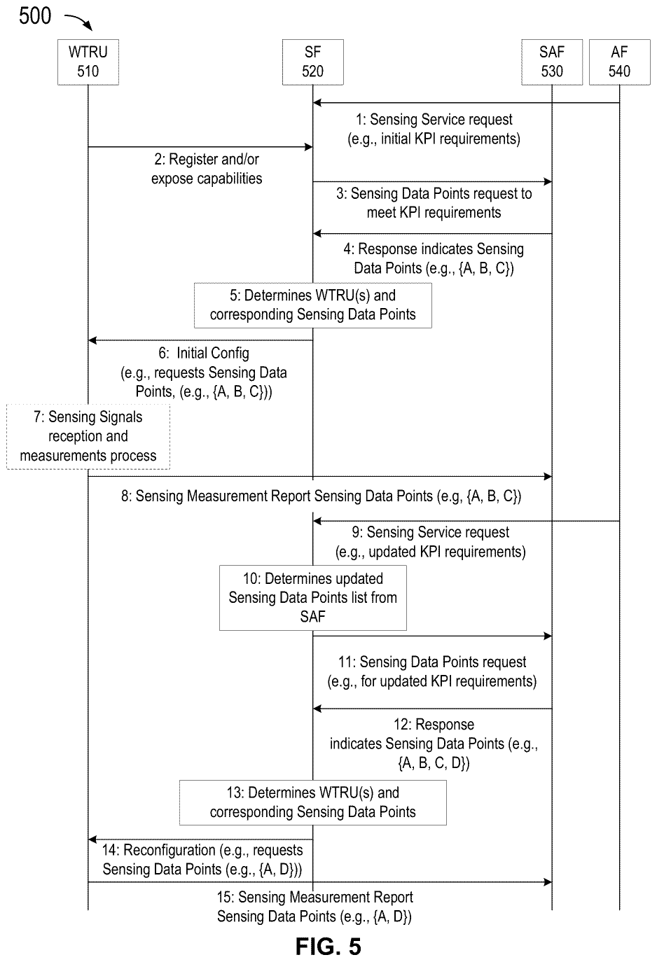

For example, a sensing function (SF) (e.g., SF 300 in FIG. 3, SF 420 in FIG. 5, or the like) is a network function. Also, for example, the SF is provided in existing 5G core network (CN) architecture. Further, for example, the SF is a logical function that either coexists alongside existing 5G network functions (NFs), or the SF functionality is part of one or more existing NFs in the 5G CN. In addition, for example, the SF coordinates sensing tasks among sensing receivers and transmitters. Moreover, for example, the SF controls the execution of sensing service requests based on KPI requirements. Furthermore, for example, the SF also receives the capabilities of sensing transmitters and sensing receivers. Additionally, for example, the SF chooses sensing transmitters and sensing receivers, e.g., WTRUs or BSs. Still further, for example, the SF coordinates the configuration of sensing receivers. Even further, for example, the SF coordinates which sensing data point each sensing receiver is to measure, as illustrated, for example, in FIG. 3. The sensing transmitters and/or receivers perform the sensing task. The SF also contains contextual information regarding the sensing tasks, target object and groups of sensing transmitters and receivers in a sensing group. The SF also reports the sensing results from an SAF to the sensing service. Yet further, for example, as shown in FIG. 3, the SF 300 maps a list of WTRUs in a sensing task, locations of the WTRUs, capabilities of the WTRUs, or the like to a set of WTRUs (e.g., a first WTRU is assigned data points A, D; a second WTRU is assigned data points B, C; and so on).

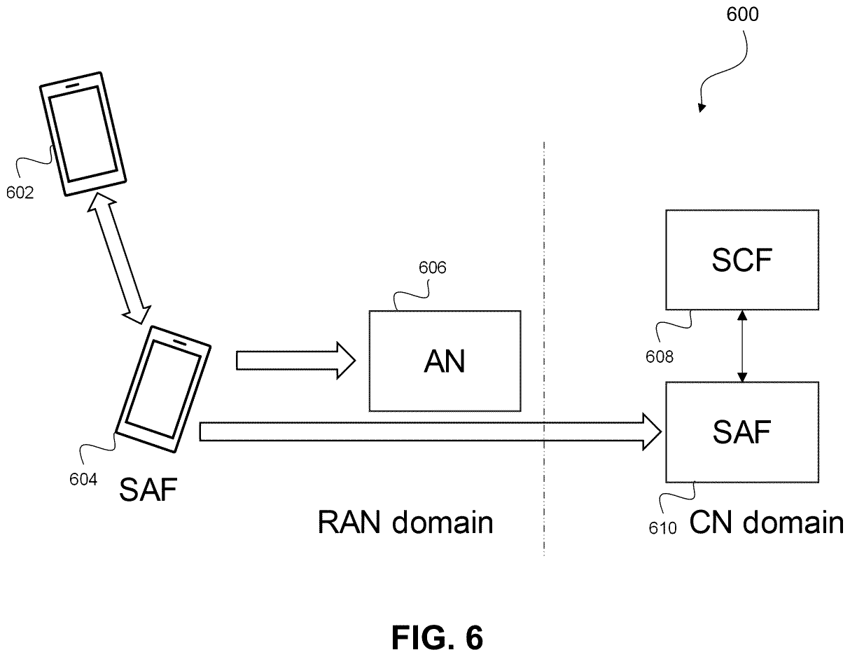

For example, a sensing analytics function (SAF) (e.g., SAF 400 in FIG. 4, SAF 530 in FIG. 5, SAF 604 or SAF 610 in FIG. 6, or the like) is a logical NF in the (e.g., 5G) core. Also, for example, the SAF can be a separate function or a part of existing NFs, e.g., part of a network data analytics function (NWDAF). The SAF can also coexist with the SF. Further, for example, the SAF collects sensing data, performs data analytics, and is responsible for generating sensing results from sensing data, as illustrated in FIG. 4. In addition, for example, as shown in FIG. 4, the SAF 400 maps one or more KPI requirements (e.g., velocity resolution, positioning accuracy, micro-doppler accuracy, or the like) to a set of sensing data points (e.g., at certain times). Moreover, for example, A, B denote data points such as delay, angles, or the like, and t_a, t_b denote the time requirements of data points A, B, respectively.

In certain representative embodiments, a WTRU reports a subset of data points configured by an SF. For example, a process 500 is provided in FIG. 5, with a sensing receiver denoted as WTRU 510. However, the general principles of the call flow 500 are equally applicable to a transmission reception point (TRP) and/or a BS as a sensing receivers. In other words, a sensing receiver may be a WTRU. Also, for example, as shown in FIG. 5, a process 500 is provided to configure a sensing receiver, e.g., one or more WTRUs or one or more BSs with data points to measure and report, and corresponding threshold values of each data point. Further, for example, the sensing receiver may be a BS instead of a WTRU.

In step 1, for example, the SF 520 receives a sensing service request from the AF 540. Also, for example, the sensing service request contains initial KPI requirements, e.g., accuracy and resolution requirements and/or positioning requirements for a target object or a set of target objects. The service request may also contain what type of target subject to be sensed, e.g., “pedestrian”, “AGV”, “vehicle,” or the like.

In step 2, for example, the WTRU 510 registers sensing capabilities of the WTRU 510 with the SF 520, e.g., either during initial registration or at a later stage by reporting its capabilities before or during the sensing task. The WTRU 510 can also update their availability of measuring a certain sensing data point.

In step 3, for example, upon receiving the sensing service KPI requirements from the AF 540 and having received the sensing capabilities of one or more WTRUs (e.g., WTRU 510), the SF 520 requests from the SAF 530 to provide the list of corresponding sensing data points to meet the KPI requirements of the requested sensing service. Also, for example, for the SAF 530 to provide such response, the SF 520 sends the KPI requirements received from the AF 540 to the SAF 530.

In step 4, for example, the SAF 530 provides a list of sensing data points to the SF 520 which are to be measured to meet the KPI requirements. The SAF 530 can also provide the time duration required for each sensing data point to be measured by the sensing receiver to meet the KPI requirements. Time requirements may be required only for one or more sensing data points, e.g., micro-doppler. The SAF 530 can determine this based on analytics performed on historical sensing data. To achieve this task, the SAF 530 may use statistical or artificial intelligence (AI) and/or machine learning (ML) models to provide these analytics.

In step 5, for example, based on WTRU 510 capabilities and other contextual information, the SF 520 chooses sensing receivers that can measure the required sensing data points to meet the sensing service KPI requirements.

In step 6, for example, the SF 520 configures the WTRU 510 with a set of sensing data points that the WTRU 510 is to measure and report. Also, for example, the set contains a list of one or more sensing data points. Further, for example, the configuration contains which sensing data point a WTRU 510 will measure, and the reporting interval for all or for each sensing data point. The reporting interval can be of type periodic, aperiodic, stream, single, or the like. The configuration can also contain information regarding target objects to be sensed.

The SF 520 can configure WTRU 510 with all sensing data points as well (e.g., since certain sensing tasks may require measurement of all sensing data points).

As an example, the SF 520 sends a configuration to the WTRU 510 to measure the sensing data points A, B, C where {A, B, C, D} are the sensing data points {delay, doppler/phase, micro-doppler, RCS} (the meaning of the mentioned sensing data points are described in further detail herein). An example configuration for such configuration is provided below, following a JSON-formatted syntax. The configuration below indicates an exemplary periodic reporting interval of 100 ms.

WTRU 510 configuration example:

{
″SensingMeasurementConfig″: {
″measurementSet″: {
″measureDelay″: true,
″measuredoppler″: true,
″measureMicrodoppler″: true,
″measureRCS″: False,
.
.
.,
″otherParameters″: {
″measurementInterval″: 50ms
}
},
″reportingConfig″: {
″reportInterval″: 100ms
}
}
}

The WTRU 510 configuration example includes the settings for a sensing measurement system. It specifies that the system will measure delay, doppler, and micro-doppler, but will not measure RCS. The measurements will be taken at intervals of 50 milliseconds. Additionally, the reporting configuration is set to generate reports every 100 milliseconds.

The SF 520 can also configure the WTRU 510 to send the sensing measurement report for a set of specific target object. In this case, configuration and corresponding data points for each target may be provided in the configuration information. For example, if a WTRU 510 is configured for two targets (e.g., robot and pedestrian), SF 520 may configure WTRU 510 to measure data points A and B for the pedestrian and data points D and C for the robot.

In one example, each WTRU 510 may be provided threshold values for each sensing data point. In this case, e.g., WTRU 510 only reports the sensing data point once it equals or exceeds the threshold value. The thresholds are kept in the WTRU 510 for as long as they are nulled or overwritten by a new threshold configuration by the SF 520. This may further reduce signaling overhead. In this case, an example configuration is as provided below

WTRU 510 configuration with thresholds example:

{
″SensingMeasurementConfig″: {
″measurementSet″: {
″measureDelay″: true,
″delayThreshold″: 0.02,
″measuredoppler″: true,
″dopplerThreshold″: 1.5,
″measureMicrodoppler″: true,
″microdopplerThreshold″: 0.1,
″measureRCS″: False,
″RCSThreshold″: 28dB snr,
.
.
.,
″otherParameters″: {
″measurementInterval″: 50ms
}
}
},
″reportingConfig″: {
″reportInterval″: ″single instance″
}
}

The WTRU 510 configuration with thresholds example is provided for a sensing measurement system and includes several detailed parameters. The system is set to measure delay, doppler, and micro-doppler, with specific thresholds for each: a delay threshold of 0.02, a doppler threshold of 1.5, and a micro-doppler threshold of 0.1. The RCS measurement is disabled, with an RCS threshold set at 28 dB SNR, although it is not being measured. Measurements are taken at intervals of 50 milliseconds. The reporting configuration is set to provide a single instance report.

In step 7, for example, the WTRU 510 receives a sensing signal and measures the configured sensing signals that are transmitted by the sensing transmitter and received by the sensing receiver, e.g., WTRU 510, to measure sensing data points in order to generate sensing data.

In step 8, for example, WTRU 510 sends the sensing measurement report to the SAF 530, that contains the list of measured sensing data points requested by the SF 520 in step 2.

The sensing measurement report may contain information such as relative position of the target to the sensing receiver.

For example, the configuration information received in step 6 is used by the WTRU 510 to send a sensing measurement report. WTRU 510 may send a sensing measurement report for a target or a set of targets to the SAF 530 for further processing.

In one example, if sensing data points thresholds are configured, the sensing measurement report may contain an indication whether the threshold is met or not. The WTRU 510 only sends the sensing measurement report if the corresponding condition is met for threshold values of each sensing data point.

An example sensing measurement report is as follows:

```
{
  ″SensingMeasurementReport″: {
    ″ueLocation″: {
      ″latitude″: 37.7749,
      ″longitude″: −122.4194,
      ″altitude″: 15.0 // in meters
    },
    ″SensingDataPoints″: {
      ″delay″: {
        ″value″: 0.025
      },
      ″doppler″: {
        ″value″: 1.8
      }
      ″microdoppler″: {
        ″value″: 0.025
  }
    }
    ″targetResults″: [
      {
        ″relativePosition″: {
          ″distance″: 15.0, // in meters
          ″bearing″: 45.0 // in degrees (relative to North)
        }
      }
    ]
  }
}
```

The example sensing measurement report provides detailed information about the system's measurements and the target's relative position. The WTRU is located at a latitude of 37.7749, a longitude of −122.4194, and an altitude of 15 meters. The sensing data points include a delay value of 0.025, a doppler value of 1.8, and a micro-doppler value of 0.025. Additionally, the report includes target results, indicating a relative position with a distance of 15 meters and a bearing of 45 degrees relative to North.

In step 9, for example, the AF 540 may update the sensing result KPI requirements for one or more ongoing tasks, e.g., the AF 540 may request precision sensing and provided requirements to the SF 520. For example, once the initial requirements of the sensing task are met, the AF 540 may send updated sensing result KPI requirements related to the previous sensing task. However, the updated requirements may not necessarily be linked to the initial sensing task and the KPI requirements. The AF 540 may send updated requirements for the same sensing task and/or a subtask, e.g., in case of DT, once the holistic sensing is performed and KPIs are met, KPI requirements for precision sensing may be given to the SF 520 to perform the new sensing task or provide updated values of the same sensing task, now performed for precision sensing.

In step 10, for example, the SF 520 determines that updated sensing data points are required from SAF 530 to meet the KPI requirements.

In step 11, for example, the SF 520 sends the updated KPI requirements to the SAF 530, and the SF 520 requests from the SAF 530 to provide the list of sensing data points for the updated KPI requirements.

In one solution, the updated KPI requirements may not be provided by the AF 540 (e.g., step 11 may not be necessary) and/or the KPI requirements of the sensing results for an ongoing sensing task are not met. SF 520 may determine to perform analytics to meet the KPI requirements of the ongoing sensing task. SF 520 may ask SAF 530 to provide a list of sensing data points for which the accuracy is not yet achieved. As an example, there may be a situation where accuracy requirements of one or more sensing data points (e.g., delay, doppler, or the like) are met and the accuracy requirements of one or more other sensing data points (e.g., micro-doppler, or the like) are not met. In this case, the SF 520 may request SAF 530 to provide an updated list of data points. Instead of measuring all data points, SAF 530 may require only a subset of sensing data points to be measured by the WTRU 510. However, this does not preclude the SF 520 from configuring the WTRU 510 with all available sensing data points (e.g., since certain sensing tasks may require the sensing receiver to measure all sensing data points).

In step 12, for example, the SAF 530 provides an updated list of sensing data points to be measured to meet the updated KPI requirements.

The data points may be linked to a target. Sensing KPI requirements for one target may be met. For another target, different data points may be required and/or data points accuracy requirements are not met and the SAF 530 requires those data points for a given target.

In one example solution, the SAF 530 may require sensing data points to improve accuracy and may require sensing data points from different WTRUs to perform fusion operations to meet KPI requirements and/or to improve accuracy (e.g., because inaccuracies lead to KPI violations).

In one example solution, SAF 530 may require one or more sensing data points to train AI/ML models, and it may require sensing data points from different WTRUs at different times to train the model. Such AI/ML models may be trained online or offline at the SAF 530 to improve sensing accuracy requirements.

In step 13, for example, The SF 520 chooses WTRU 510, and a set of sensing data points the WTRU 510 will measure and report (refer to step 5 for more details).

In step 14, for example, The SF 520 configures the WTRU 510 with the sensing data points the WTRU 510 will measure and report on. The SF 520 can choose different WTRUs for the same target to have sensing data from different WTRU 510 perspectives.

An example of (re)configuration is provided as follows, in which the WTRU 510 is configured to measure delay and micro-doppler only, e.g., sensing data points A and D. The WTRU 510 is also configured to send periodic report with periodicity of 100 ms.

WTRU 510 (re)configuration example:

{
″SensingMeasurementConfig″: {
″measurementSet″: {
″measureDelay″: true,
″measuredoppler″: False,
″measureMicrodoppler″: False,
″measureRCS″: True,
.
.
.
″otherParameters″: {
″measurementInterval″: 100ms
}
},
″reportingConfig″: {
″reportInterval″: ″periodic″
}
}
}

The WTRU 510 (re)configuration example for the sensing measurement system specifies that the system will measure delay and RCS, but will not measure doppler or micro-doppler. Measurements will be taken at intervals of 100 milliseconds. The reporting configuration is set to provide periodic reports.

In the same way as step 6, the SF 520 can configure the WTRU 510 with threshold values for each sensing data point that is requested by the SF 520. The SF 520 may update the threshold values with updated KPI requirements and/or if KPI requirements of the existing task are not met.

In step 15, for example, the WTRU 510 sends the sensing measurement report with only requested sensing data points, e.g., {A, D}.

In one solution, the WTRU 510 may send the report if one or more threshold conditions of all requested data points is met. In one solution, the WTRU 510 may send the report if one or more threshold conditions of one or more data points is met. The SF 520 can configure this reporting behavior as well.

In one solution, KPI requirements for all tasks (e.g., holistic sensing and precision) may be provided in step 1, the sensing service request. Step 1 and step 9 may be performed together. For example, the AF 540 may provide KPI requirements for sensing results related to two sensing tasks and the indication of which task is to be performed first and which task is to be performed followed by the first and so on.

FIG. 6 shows an illustration of features 600 which may be utilized for sensing. WTRUs 602, 604 are shown, along with access node (AN) 606, sensing coordination function (SCF) 608, and sensing analytics function (SAF) 610. SCF 608 and SAF 610 may generally correspond to SCF 187a, 187b, and SAF 188a, 188b described in connection with FIG. 1D.

These features may enable broader sensing operations and are depicted in FIG. 6. This illustration of features 600 does not define the new system functionalities as new mobile network entities, but merely discusses their functionalities.

In some examples, the SCF 608 may coordinate a sensing operation in various respects which may, for example, include full management of sensing sources of sensing data, non-3GPP sensing data, sensing results, and sensing contextual information, including source selection, activation, de-activation, configuration and activation/de-activation of reporting from sources, or the like, with the sources for example being an individual sensing transmitter, receiver, or a sensing group. Additionally or alternatively, the SCF may control activation/de-activation and/or switching of sensing modes.

In some examples, the SAF 610 may perform, based on the collected sensing data and/or results, analytics over sensing data, sensing results, or both, and may be capable of generating additional sensing data, sensing results, and sensing contextual information. The SAF 610 may further generate insights over sensing data, results or contextual information, e.g., by applying statistical, probabilistic, or AI/ML methods in general. The SAF 610 may perform a fusion of sensing data from multiple sources, e.g., can combine different sensing data, results and/or contextual information from any sensing source and generate further data from that fusion process.

The SAF 610 may be able to expose the gathered or generated information to application servers in a data network (DN), for example via a network exposure function (NEF), and/or to an application function (AF).

In some examples, the SCF 608 and SAF 610 functionalities may reside within a core network (CN) which may be Core Network 115 of FIG. 1D. In some examples, the SCF 608 and SAF 610 may reside elsewhere, for example in the RAN domain. In the example shown in FIG. 6, SAF functionality is shown running in a WTRU 604.

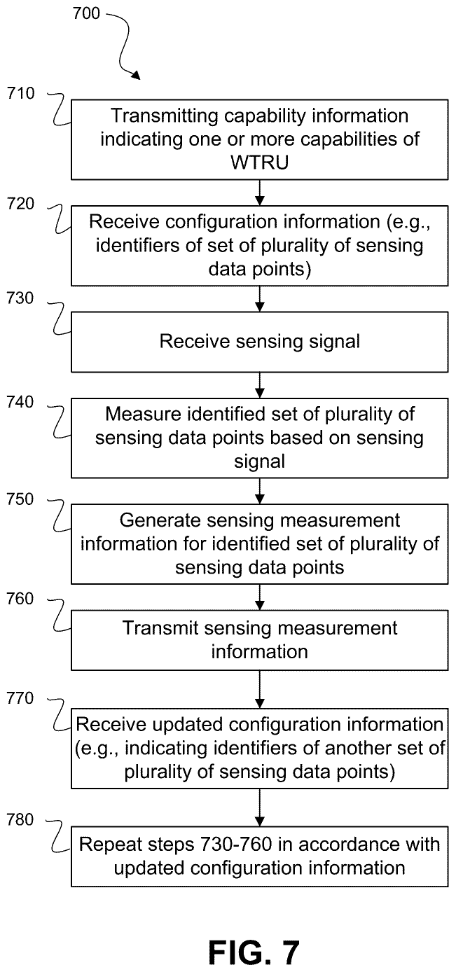

In certain representative embodiments, as shown in FIG. 7, a method 700 is performed by a wireless transmit/receive unit (WTRU) (e.g., WTRU 102, 210, 220, 510, 602, 604, or the like) in communication with a wireless network (e.g., CN 106, 115, 270, the CN domain of FIG. 6, or the like). For example, the method 700 comprises at least one of transmitting 710, to the wireless network, capability information indicating one or more capabilities of the WTRU (e.g., step 2 of FIG. 5); receiving 720, from the wireless network, configuration information, the configuration information comprising identifiers of a set of a plurality of sensing data points (e.g., step 6 of FIG. 5); receiving 730 a sensing signal in accordance with the configuration information; measuring 740 the identified set of the plurality of sensing data points based on the sensing signal in accordance with the configuration information (e.g., step 7, of FIG. 5); generating 750 sensing measurement information for the identified set of the plurality of sensing data points in accordance with the configuration information (e.g., step 7, of FIG. 5); transmitting 760, to the wireless network, the sensing measurement information in accordance with the configuration information (e.g., step 8, of FIG. 5); receiving 770, from the wireless network, updated configuration information, the updated configuration information indicating identifiers of another set of a plurality of sensing data points (e.g., step 14, of FIG. 5); repeating 780 steps 730-760 in accordance with the updated configuration information; combinations of the same; or the like. Also, for example, the capability information indicates one or more sensing data points for measurement. Further, for example, the configuration information further indicates a reporting interval for each of the identified set of the plurality of sensing data points. In addition, for example, the reporting interval is at least one of periodic, aperiodic, stream, or single. Moreover, for example, the configuration information further indicates a reporting interval for each sensing data point. Furthermore, for example, the reporting interval is adjustable based on a type of sensing data point and a target object to be sensed. Additionally, for example, the configuration information further indicates one or more threshold values for one or more of the identified set of the plurality of sensing data points. Still further, for example, the transmitting 760 of the sensing measurement information is performed based on the measured values of the sensing data points meeting or exceeding the corresponding one or more threshold values. Even further, for example, the threshold values are adjustable based on network conditions, and the updated configuration information indicates an updated threshold value for one sensing data point of the another set of the plurality of sensing data points. Yet further, for example, the transmitted sensing measurement information is received at a sensing analytics function (SAF) (e.g., SAF 188a, 188b, 400, 530, 604, 610, or the like) of the wireless network.

In certain representative embodiments, a wireless transmit/receive unit (WTRU) (e.g., WTRU 102, 210, 220, 510, 602, 604, or the like) is provided in communication with a wireless network (e.g., CN 106, 115, 270, the CN domain of FIG. 6, or the like). For example, the WTRU comprises a processor; and a transceiver coupled to the processor. Also, for example, the WTRU is configured to perform one or more of the steps of method 700 described herein.

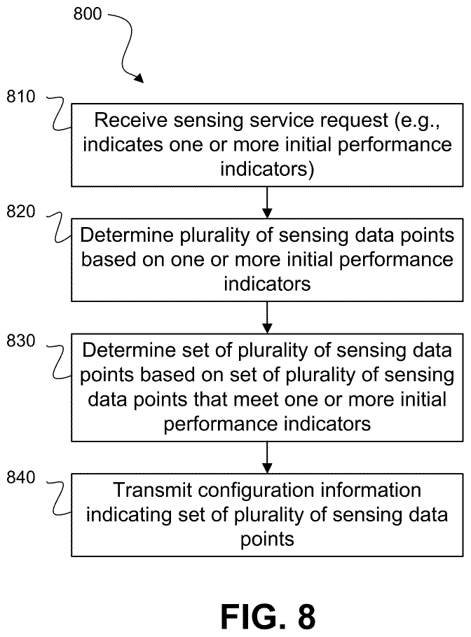

In certain representative embodiments, as shown in FIG. 8, a method 800 is performed by a wireless network (e.g., CN 106, 115, 270, the CN domain of FIG. 6, or the like) in communication with a wireless transmit/receive unit (WTRU) (e.g., WTRU 102, 210, 220, 510, 602, 604, or the like). For example, the method 800 comprises at least one of receiving 810 a sensing service request, wherein the sensing service request indicates one or more initial performance indicators (e.g., step 1, of FIG. 5); determining 820 a plurality of sensing data points based on the one or more initial performance indicators (e.g., step 4, of FIG. 5); determining 830, for the WTRU, a set of the plurality of sensing data points based on the set of the plurality of sensing data points that meet the one or more initial performance indicators (e.g., step 5, of FIG. 5); transmitting 840, to the WTRU, configuration information indicating the set of the plurality of sensing data points (e.g., step 6, of FIG. 5); combinations of the same; or the like. Also, for example, the sensing service request is received by a sensing function (SF) (e.g., SF 300, 520, or the like) of the wireless network from an application function (AF) (e.g., 540, or the like) of the wireless network (e.g., step 1, of FIG. 5). Further, for example, the request to provide identifiers of the set of the plurality of sensing data points is received by a sensing analytics function (SAF) (e.g., SAF 188a, 188b, 400, 530, 604, 610, or the like) of the wireless network from the SF (e.g., step 2, of FIG. 5). In addition, for example, the set of the plurality of sensing data points is initially determined at the SAF (e.g., step 4, of FIG. 5). Moreover, for example, the initially determined set is sent from the SAF to the SF (e.g., step 4, of FIG. 5). Furthermore, for example, a subset of the set of the plurality of sensing data points is determined for the WTRU at the SF (e.g., step 5, of FIG. 5). Additionally, for example, the configuration information is transmitted from the SF to the WTRU (e.g., step 6, of FIG. 5).

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery or the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type of medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6, 35 U.S.C. § 112(f) or means-plus-function claim format, and any claim without the terms “means for” is not so intended.

What is claimed:

1. A method performed by a wireless transmit/receive unit (WTRU) in communication with a wireless network, the method comprising:
transmitting, to the wireless network, capability information indicating one or more capabilities of the WTRU;
receiving, from the wireless network, configuration information, the configuration information comprising identifiers of a set of a plurality of sensing data points;
in accordance with the configuration information:
(a) receiving a sensing signal;
(b) measuring the identified set of the plurality of sensing data points based on the sensing signal;
(c) generating sensing measurement information for the identified set of the plurality of sensing data points; and
(d) transmitting, to the wireless network, the sensing measurement information;
receiving, from the wireless network, updated configuration information, the updated configuration information indicating identifiers of another set of a plurality of sensing data points; and
repeating steps (a)-(d) in accordance with the updated configuration information.

2. The method of claim 1, wherein:
the capability information indicates one or more sensing data points for measurement.

3. The method of claim 1, wherein
the configuration information further indicates a reporting interval for each of the identified set of the plurality of sensing data points, and
the reporting interval is at least one of periodic, aperiodic, stream, or single.

4. The method of claim 1, wherein:
the configuration information further indicates a reporting interval for each sensing data point, and
the reporting interval is adjustable based on a type of sensing data point and a target object to be sensed.

5. The method of claim 1, wherein:
the configuration information further indicates one or more threshold values for one or more of the identified set of the plurality of sensing data points, and
the transmitting of the sensing measurement information is performed based on the measured values of the sensing data points meeting or exceeding the corresponding one or more threshold values.

6. The method of claim 5, wherein the threshold values are adjustable based on network conditions, and the updated configuration information indicates an updated threshold value for one sensing data point of the another set of the plurality of sensing data points.

7. The method of claim 1, wherein the transmitted sensing measurement information is received at a sensing analytics function (SAF) of the wireless network.

8. A wireless transmit/receive unit (WTRU) in communication with a wireless network, the WTRU comprising:
a processor; and
a transceiver coupled to the processor, wherein the WTRU is configured to:
transmit, to the wireless network, capability information indicating one or more capabilities of the WTRU;
receive, from the wireless network, configuration information, the configuration information comprising identifiers of a set of a plurality of sensing data points;
in accordance with the configuration information:
(a) receive a sensing signal;
(b) measure the identified set of the plurality of sensing data points based on the sensing signal;
(c) generate sensing measurement information for the identified set of the plurality of sensing data points; and
(d) transmit, to the wireless network, the sensing measurement information;
receive, from the wireless network, updated configuration information, the updated configuration information indicating identifiers of another set of a plurality of sensing data points; and
repeat steps (a)-(d) in accordance with the updated configuration information.

9. The WTRU of claim 8, wherein:
the capability information indicates one or more sensing data points for measurement.

10. The WTRU of claim 8, wherein
the configuration information further indicates a reporting interval for each of the identified set of the plurality of sensing data points, and
the reporting interval is at least one of periodic, aperiodic, stream, or single.

11. The WTRU of claim 8, wherein:
the configuration information further indicates a reporting interval for each sensing data point, and
the reporting interval is adjustable based on a type of sensing data point and a target object to be sensed.

12. The WTRU of claim 8, wherein:
the configuration information further indicates one or more threshold values for one or more of the identified set of the plurality of sensing data points, and
the transmitting of the sensing measurement information is performed based on the measured values of the sensing data points meeting or exceeding the corresponding one or more threshold values.

13. The WTRU of claim 12, wherein the threshold values are adjustable based on network conditions, and the updated configuration information indicates an updated threshold value for one sensing data point of the another set of the plurality of sensing data points.

14. The WTRU of claim 8, wherein the transmitted sensing measurement information is received at a sensing analytics function (SAF) of the wireless network.

15. A method performed by a wireless network in communication with a wireless transmit/receive unit (WTRU), the method comprising:
receiving a sensing service request, wherein the sensing service request indicates one or more initial performance indicators;
determining a plurality of sensing data points based on the one or more initial performance indicators;
determining, for the WTRU, a set of the plurality of sensing data points based on the set of the plurality of sensing data points that meet the one or more initial performance indicators; and
transmitting, to the WTRU, configuration information indicating the set of the plurality of sensing data points.

16. The method of claim 15, wherein:
the sensing service request is received by a sensing function (SF) of the wireless network from an application function (AF) of the wireless network,
the request to provide identifiers of the set of the plurality of sensing data points is received by a sensing analytics function (SAF) of the wireless network from the SF,
the set of the plurality of sensing data points is initially determined at the SAF,
the initially determined set is sent from the SAF to the SF,
a subset of the set of the plurality of sensing data points is determined for the WTRU at the SF, and
the configuration information is transmitted from the SF to the WTRU.
